(19) United States
(12) Patent Application Publication
(10) Pub. No.: US 2023/0381058 A1
(43) Pub. Date: Nov. 30, 2023

(54) OSCILLATING DEVICE FOR TEMPOROMANDIBULAR JOINT

(71) Applicant: THE ROYAL INSTITUTION FOR THE ADVANCEMENT OF LEARNING/MCGILL UNIVERSITY, Montreal (CA)

(72) Inventors: Natalie REZNIKOV, Montreal (CA); Alexei V. MOROZOV, Verdun (CA); Julia WARREN, Pointe-Claire (CA); Maxim VITALE, Kirkland (CA); Winston TRAN, Verdun (CA); Wilfred MASON, Laval (CA)

(21) Appl. No.: 18/202,005

(22) Filed: May 25, 2023

Related U.S. Application Data
(60) Provisional application No. 63/345,648, filed on May 25, 2022.

(51) Int. Cl. A61H 23/02

(52) U.S. Cl. CPC A61H 23/0236; A61H 23/0245; A61H 2201/1607; A61H 2201/1621; A61H 2201/1652; A61H 2205/026; A61H 2201/5005; A61H 2201/1418; A61H 2201/1611

(57) ABSTRACT

A system for mitigating temporomandibular joint disorders, comprising: a support to be worn by a wearer; an array of vibration units mounted to the support and each including an actuator and a vibrating pad in driving engagement with the actuator, the vibration units including a right mandible-engaging unit, a left mandible-engaging unit, and a sternum-engaging unit, the right mandible-engaging unit including a right mandible-engaging vibrating pad, the left mandible-engaging unit including a left mandible-engaging vibrating pad, and the sternum-engaging unit including a sternum-engaging vibrating pad; and a controller in communication with the actuators of each of the vibration units, the controller configured to activate one or more of the actuators in order to induce vibration of the vibrating pad of the respective vibration unit at a selected frequency and amplitude.

### CROSS-REFERENCE TO RELATED APPLICATIONS

This application claims priority from U.S. patent application 63/345,648 filed on May 25, 2022, the entire contents of which are incorporated herein by reference.

### TECHNICAL FIELD

The disclosure relates generally to medical devices and, more particularly, to medical devices that may be used for the temporomandibular joint, for example to alleviate temporomandibular joint disorders and/or obstructive sleep apnea via improvement of the mandibular posture.

### BACKGROUND

Temporomandibular joint (TMJ) disorders comprise a group of increasingly common chronic disorders of poorly understood etiology. These conditions may include pain, tenderness, discomfort, joint clicking, and movement limitations in the TMJ. These disorders may be attributed to trauma or arthritis, but in many cases, the specific cause is difficult to identify. Prevalence of these symptoms can vary between 5% to 12% of the population. Unlike other chronic pain conditions, TMJ disorders are more common among younger individuals, and females are affected about twice as often as males. The onset of TMJ disorders may be spontaneous, or associated with stress and anxiety, and the symptoms may ease or aggravate over time. Because of this generally nebulous natural history of TMJ disorders, mostly conservative care is recommended. This includes cognitive-behavioral therapy, eating a soft diet, and the use of anti-anxiety medications and/or pain medications. Of note, it is not uncommon to observe co-occurrence of TMJ disorders and neck pain, while both are associated with anxiety, poor overall body posture and a sedentary lifestyle. Although the link could be coincidental, both TMJ disorders and obstructive sleep apnea (OSA) can be associated with impaired sleep quality and sleep bruxism, the latter often resulting in dental attrition.

If dental attrition, also referred to as tooth wear, or periodontal trauma become of concern, oral appliances such as night guards or stabilizing splints can be used. Application of botulinum toxin for intramuscular injections can be effective, but its effects wear off after several months, and it is expensive and difficult to gauge the amount to be administered. Irreversible treatment modes such as tooth “occlusional adjustment”, or grinding down of tooth enamel, are of dubious efficacy. Surgical treatment of the joint itself is the last resort in the rare cases of arthritis, neoplasm or trauma. Thus, the overarching characteristic of all noninvasive or semi-invasive treatments is their palliative or symptom-oriented nature. Hence, improvements in treating TMJ disorders are sought.

### SUMMARY

In one aspect, there is provided a system for mitigating temporomandibular joint disorders, comprising: at least one support adapted to be worn by a wearer; an array of vibration units mounted to the at least one support and spaced apart from each other, each of the vibration units including an actuator and a vibrating pad in driving engagement with the actuator, the vibration units including a right mandible-engaging unit, a left mandible-engaging unit, and a sternum-engaging unit, the right mandible-engaging unit including a right mandible-engaging vibrating pad for engaging a right side of a mandible of the wearer, the left mandible-engaging unit including a left mandible-engaging vibrating pad for engaging a left side of the mandible of the wearer, and the sternum-engaging unit including a sternum-engaging vibrating pad for engaging a sternum of the wearer; and a controller in communication with the actuators of each of the vibration units, the controller configured to activate one or more of the actuators in order to induce vibration of the vibrating pad of the respective vibration unit at a selected frequency and amplitude.

The system described above may include any of the following features, in any combinations.

In some embodiments, the actuators of each of the vibration units is an acoustic actuator.

In some embodiments, the acoustic actuator includes a housing, an acoustic vibrator engaged to a respective one of the pads, the acoustic vibrator mounted within the housing, actuation of the acoustic vibrator induces a reciprocating motion of a respective one of the pads.

In some embodiments, the selected frequency of the vibrations ranges from 100 Hz to 300 Hz.

In some embodiments, the selected amplitude of the vibrations ranges from 1 mm to 5 mm.

In some embodiments, the support is a harness, the left mandible-engaging unit, the right mandible-engaging unit, and the sternum-engaging unit are secured to the harness.

In some embodiments, the harness defines a U-shape having an inner neck-receiving space, the harness shaped to wrap around a neck of the wearer.

In some embodiments, the controller is mounted to the harness.

In some embodiments, the actuator includes: a housing; an electric motor mounted within the housing; a cam drivingly engaged by the electric motor; and a cam follower engaged by the cam; wherein actuation of the electric motor induces rotation of the cam about a cam axis and a reciprocating motion of the cam follower about a follower axis.

In some embodiments, two shafts are mounted within the housing, the cam follower slidingly engaged to the two shafts.

In some embodiments, biasing members are disposed around the two shafts and engaged to the cam follower.

In some embodiments, the pads are mounted on the cam follower of each of three actuators.

In another aspect, there is provided a method of mitigating temporomandibular joint disorders, comprising: vibrating a pair of mandible-engaging pads adapted to be mounted against a mandible of a patient; and vibrating a sternum-engaging pad adapted to be mounted against a sternum of the patient.

The method described above may include any of the following features, in any combinations.

In some embodiments, the vibrating of the pair of the mandible-engaging pads and the vibrating of the sternum-engaging pad includes vibrating the pair of the mandible-engaging pads and the sternum-engaging pad with three actuators each drivingly engaged to a respective one of the mandible-engaging pads and the sternum-engaging pad.

In some embodiments, the vibrating the pair of the mandible-engaging pads and the sternum-engaging pad with three actuators includes vibrating the pair of the mandible-engaging pads and the sternum-engaging pad with three acoustic actuators.

In some embodiments, the vibrating of the pair of the mandible-engaging pads and the vibrating of the sternum-engaging pad includes vibrating the pair of the mandible-engaging pads and the sternum-engaging pad at a frequency ranging from 100 Hz to 300 Hz.

In some embodiments, the vibrating of the pair of the mandible-engaging pads and the vibrating of the sternum-engaging pad includes vibrating the pair of the mandible-engaging pads and the sternum-engaging pad at an amplitude ranging from 1 mm to 5 mm.

In some embodiments, the method includes supporting the mandible-engaging pads and the sternum-engaging pad with a harness.

In some embodiments, the method includes receiving a neck of a wearer within a neck-receiving space of the harness.

The system described above may be used for mitigating pains associated with Parkinson's disease.

The oscillating device of the present disclosure is intended to be used as a physiotherapy appliance for clinical conditions having an abnormal muscular tone in the face and neck area and habitual (acquired) abnormal position of the lower jaw (mandible) and neck. This device may lower the muscular tone of the muscles that control the three dimensional position (“posture”) of the mandible within the craniofacial complex by applying mechanical vibrations. In some embodiments, the vibrations have a frequency range of about 80 to about 300 Hz, or alternatively 100 to 300 Hz, but other frequency values are also contemplated, such as from 100-200 Hz. Such vibrations are applied to the muscles that displace the mandible posteriorly and may induce a relief of habitual muscular tone. Thus, the device may functionally resolve posteriorly displaced (retrognathic) occlusion of the mandible, and alleviate clenching of teeth and may alleviate overloading of the TMJ. When the mandible regains its physiologic neutral position where teeth are normally out of contact at rest, the forced backwards displacement of the tongue and the pharynx may naturally resolve. This may improve the patency of the upper airways. Applying vibration in bouts repeated over the course of treatment may restore the neutral posture of the mandible. In the long term, this may alleviate dental clenching, temporomandibular joint pain and dysfunction, obstructive sleep apnea, certain varieties of neck pain, and may improve head posture and facial appearance in the subject. This device may target the parafunctional character of TMJ disorders.

A principle behind the disclosed devices is that correction of posture involving reconditioning and relaxation of the hyoid depressors (infrahyoid muscles), and also involving protrusion of the mandible, may together alleviate the persistent spastic state of all of the muscles involved in mandibular movement and may restore their appropriate iterative contractile ability, and may also unload the temporomandibular joint and dentition. The disclosed device may apply from 100-300 Hz reciprocating tapping to attachment sides of the mouth-closing muscles and the hyoid depressors. The vibrating elements may rest on the mandibular angle and the upper part of the sternum (chest bone). In some embodiments, an amplitude of oscillation is from 1 mm to 3-5 mm. The anatomically-shaped onlays may be designed and 3D-printed to fit average individuals. The device may be used in an outpatient setting by dentists or medical doctors specialized in temporomandibular dysfunctions/parafunctions, pain, and obstructive sleep apnea. In some embodiments, the device, may be used at home, office, or gym.

The device may alleviate bruxism, dental clenching, temporomandibular joint pain and dysfunction, obstructive sleep apnea, certain varieties of neck pain, and improve head posture and facial appearance of the individual.

In one aspect, there is accordingly provided a system for temporomandibular joints, comprising: mandible-engaging pads for engaging a mandible of a wearer; a sternum-engaging pad for engaging a sternum of the wearer; and an oscillating system operatively connected to the mandible-engaging pads and the sternum-engaging pad, the oscillating system including at least one actuator operable to induce vibrations of the mandible-engaging pads and the sternum-engaging pad.

In another aspect, there is provided a method of operating a system adapted for treating temporomandibular joint disorders, comprising: inducing first vibrations in a pair of mandible-engaging pads adapted to be mounted against mandibles of a patient; inducing second vibrations a sternum-engaging pad adapted to be mounted against a sternum of the patient; and controlling the first vibrations and the second vibrations to be between 60 and 600 Hz.

The system and/or method as defined above and described herein may include one or more the following features, in whole or in part, and in any combination.

In some embodiments, the at least one actuator includes three actuators each engaged to a respective one of the mandible-engaging pads and the sternum-engaging pad.

In some embodiments, each of the three actuators includes: a housing; an electric motor mounted within the housing; a cam drivingly engaged by the electric motor; and a cam follower engaged by the cam; wherein actuation of the electric motor induces rotation of the cam about a cam axis and a reciprocating motion of the cam follower about a follower axis.

In some embodiments, the system includes two shafts mounted within the housing, the cam follower slidingly engaged to the two shafts.

In some embodiments, the system includes biasing members disposed around the two shafts and engaged to the cam follower.

In some embodiments, the mandible-engaging pads and the sternum-engaging pad are mounted on the cam follower of each of the three actuators.

In some embodiments, the system includes onlays mounted to the mandible-engaging pads and the sternum-engaging pad, the onlays made of a customizable material.

In some embodiments, the mandible-engaging pad defines a curved surface, an angle of the curved surface being about 120 degrees to match a shape of the mandible.

In some embodiments, the sternum-engaging pad is one of square, hexagonal, circular, and rectangular.

In some embodiments, the mandible-engaging pads and the sternum-engaging pad have each a contact area for contacting the wearer, the contact area being about 10 cm2.

In some embodiments, the at least one actuator is operable to vibrate at a frequency ranging from 100 Hz to 300 Hz.

In some embodiments, an amplitude of movement of the at least one actuator is from 1 mm to 5 mm.

### BRIEF DESCRIPTION OF THE DRAWINGS

Reference is now made to the accompanying figures in which:

FIG. 1 is a schematic side view of the anatomy of a head, mandible, and neck of a human illustrating distinct functional groups of muscles that define the mandibular posture;

FIG. 2 is a simplified schematic view of the functional groups of muscles that directly control the mandible and indirectly control the hyoid; the muscles being depicted as a closed kinematic chain diagram;

FIG. 3 is a three dimensional view of an exemplary setup including an oscillating device in accordance with the present disclosure that may be used for treating temporomandibular joint (TMJ) disorders in a clinical set-up;

FIG. 4 is a top three-dimensional view of the oscillating device of FIG. 3;

FIG. 5 is an exploded three-dimensional view of the oscillating device of FIGS. 3 and 4;

FIGS. 6 and 7 are three-dimensional views of mandibular onlays of the device of FIGS. 4-5;

FIG. 8 is a three-dimensional view illustrating a mandible engaged by the mandibular onlays of FIGS. 6 and 7;

FIG. 9 is a front view illustrating a system for temporomandibular joint disorder in accordance with another embodiment;

FIG. 10 is a three dimensional view of an actuator of the system of FIG. 9;

FIG. 11 is a three dimensional exploded view of the actuator of FIG. 10;

FIG. 12 is a top view of a cam of the actuator of FIG. 10;

FIG. 13 is a three dimensional view of inner components of the actuator of FIG. 10;

FIG. 14 is a three dimensional view of a sternum-engaging pad in accordance with another embodiment;

FIG. 15 is a three dimensional view of a mandible-engaging pad in accordance with another embodiment;

FIG. 16 is a three dimensional view of a chest mount used for supporting one of the actuator of FIG. 19 against a chest of a user;

FIG. 17 is a three dimensional view illustrating the actuator of FIG. 10 installed within the chest mount of FIG. 16;

FIG. 18 is a front view illustrating a system for temporomandibular joint disorder in accordance with another embodiment;

FIG. 19 is a three dimensional partially exploded view of an actuator in accordance with another embodiment;

FIG. 20 is a front view of a system for temporomandibular joint disorder in accordance with another embodiment;

FIG. 21 is a side three dimensional view of a system for temporomandibular joint disorder in accordance with another embodiment;

FIG. 22 is a side view of the system of FIG. 21;

FIG. 23 is a flowchart illustrating steps of a method for mitigating temporomandibular joint disorders; and

FIG. 24 is a schematic view illustrating a control system for a system for temporomandibular joint disorder.

### DETAILED DESCRIPTION

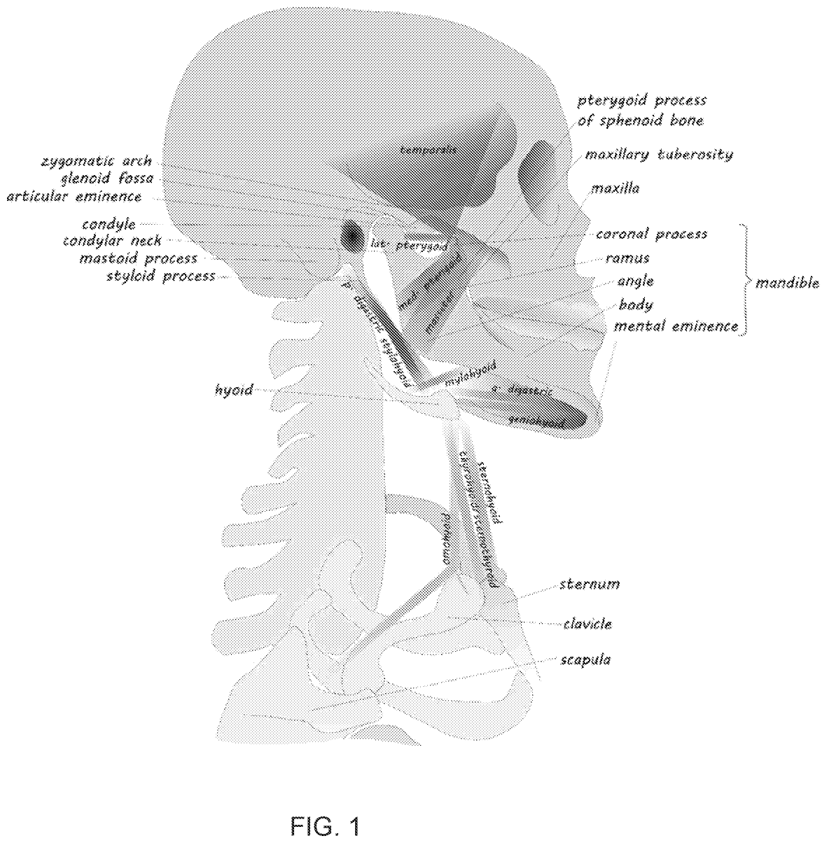

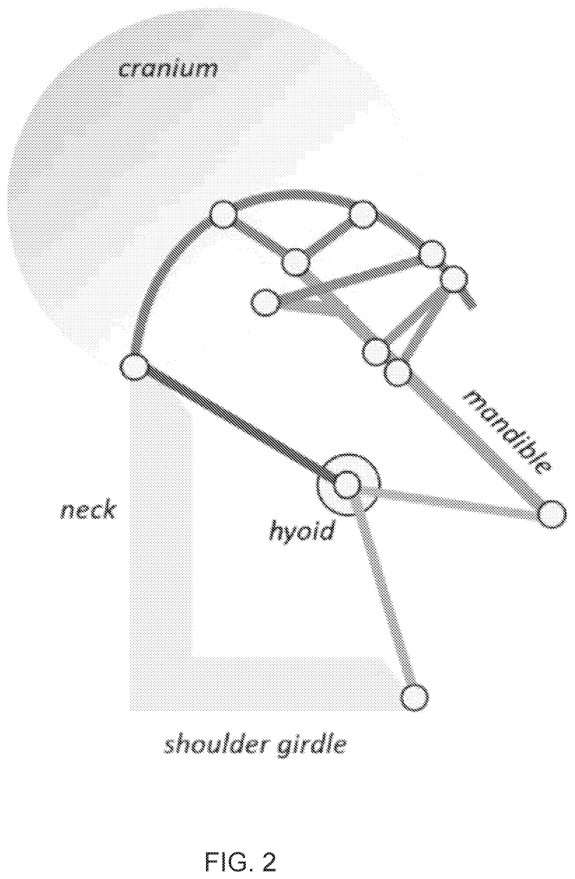

Referring to FIGS. 1-2, the functional anatomy of the head and neck muscles of the human body is shown. The temporomandibular joint (TMJ) is the most peculiar joint in the human body. It is a paired joint in which movement occurs simultaneously, but not necessarily symmetrically, on both sides of the head. The part of the temporal bone with which the mandibular condyle articulates is in fact remarkably “paper-thin”. This lack of strong supportive bone at this putative fulcrum for mandibular function suggests that TMJ movement follow the principles of closed kinematic chain operation rather than of a Class III lever. Closed kinematic chains, which are kinematic chains where the two ends of the series are fixed, are assemblies of multiple moving elements that can be selectively stabilized by muscles for steadiness, power and control of versatile movements. From a functional perspective, the most influential element of the closed kinematic chain involving the TMJ is not the mandible, but the hyoid bone. The hyoid bone is connected to the cranial base, to the mandible, and to the shoulder girdle by sixteen muscles that belong to three distinct functional groups (depressors, retractors and mouth openers) which receive innervation independently from three cranial nerves. Thus, the hyoid bone is the “puppeteer” of the craniofacial biomechanics. It is involved not only in the normal three dimensional movements of the mandible, but also in the abnormal persistent retrognathic posture of the mandible. It is thus possibly involved in parafunctions and pathologies such as TMJ pain, dental attrition, obstructive sleep apnea and snoring, malocclusion, neck pain, and neck fatigue.

Although mandibular retrognathic occlusion (“tucked backwards”) with forceful closure—beyond the “regular” force exerted during normal mastication—is acutely uncomfortable, such chronic, parafunctional position typically accompanies such emotional states as anger and frustration. It is a typical physiognomic feature of competitiveness, stress, tension and anxiety (“clenched jaws look”). Forceful mandibular retrognathic occlusion is directly associated with various combinations of TMJ pain, dental attrition and occlusal trauma, chronic neck pain, and posterior displacement of the tongue. The latter symptom is of particular importance as the intrinsic muscles of the tongue—the genioglossus and the hyoglossus—originate from the floor of the mouth, which is itself displaced posteriorly together with the mandible and the hyoid bone. Glossal blockage is responsible for many cases of obstructive sleep apnea which is highly associated with the presentation of TMJ dysfunction and orofacial pain. The strong psychosomatic involvement in such a posture results in—instead of switching of the activities of various muscle modules (mandible openers and closers, and hyoid retractors and depressors)—a simultaneous contraction and a spastic state that persists, distorting the neutral, relaxed habitual posture of the mandible and the head, muscle proprioception, and voluntary postural control. Understandably, the correction of the mandibular position is unattainable without addressing the muscular tone of the entire anatomical unit, and in particular the muscles that anchor the hyoid bone to the shoulder girdle and the cranial base.

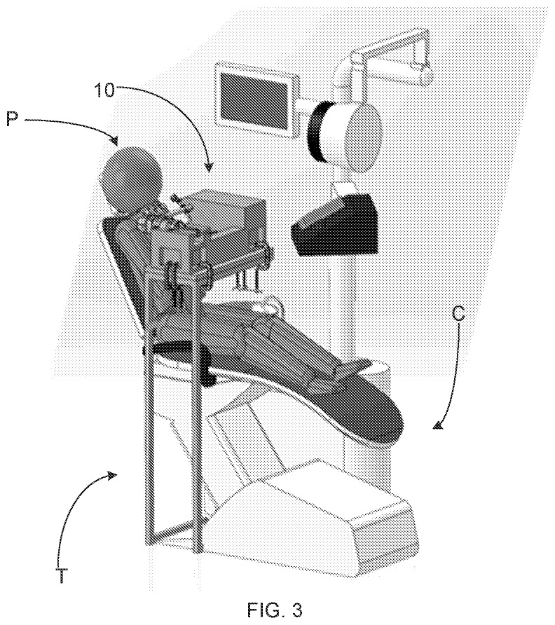

Referring now to FIG. 3, an oscillating device used to at least partially alleviate TMJ disorders is shown at 10. As will be described below, the oscillating device 10 uses vibrations to recondition muscular tone stems. The theory behind the vibration-based reconditioning of muscular tone stems from the physiology of impulse transmission at neuromuscular junctions. Muscular contractions require a neural signal, and the power of contraction depends on the coordination amongst myriads of individual muscle cells, called myocytes. Even the resting muscular tone, which is a normal state of a live organism, requires continuous electric stimulation to occur at the neuromuscular synapses of motoneurons. During that process, ionic flow across the myocyte membrane is momentarily allowed, the membrane potential reverses, and the myocyte contracts. Following each contraction, the concentrations of different ions must be restored by transmembrane ionic pumps to render the cell responsive to the next signal. Therefore, for a short time immediately after a contraction, myocytes enter the so-called refractory state. As well, muscle tissue contain muscle stretch receptors, and tendons contain tendon stretch receptors, which are also known as Golgi tendon organs, or spindles. These spindle-shaped receptors are connected to the motoneuron and provide a protective negative feedback loop: when the muscle is in a state of a strong contraction, and therefore the tendon is under tension, the signal from the tendon spindle overrides the motoneuron and causes muscle relaxation. It is assumed that mechanical vibration may induce muscle relaxation via two possible mechanisms. Firstly, each vibration stroke imparted by the oscillating device 10 may gently and repetitively stretch the tendon spindles, and that induces inhibition of the motoneuron. Secondly, high-frequency looping of the activation-inhibition cycles induces a prolonged collective refractory period in the target muscle myocytes. The effective frequency depends on the speed of the neural impulse propagation through axons, and the length of the neuromuscular circuit.

Still referring to FIG. 3, the oscillating device 10 may be designed to be used at a dental clinic, for example only. The oscillating device 10 may be mounted on a table T and/or on a dental chair C. Hence, the oscillating device 10 may be a treatment device used, in some cases, to periodically treat a patient P. It will be appreciated that, in some variants, the oscillating device 10 may be mounted to a table for home use by the patient P, or may be mobile or otherwise mounted, as necessary.

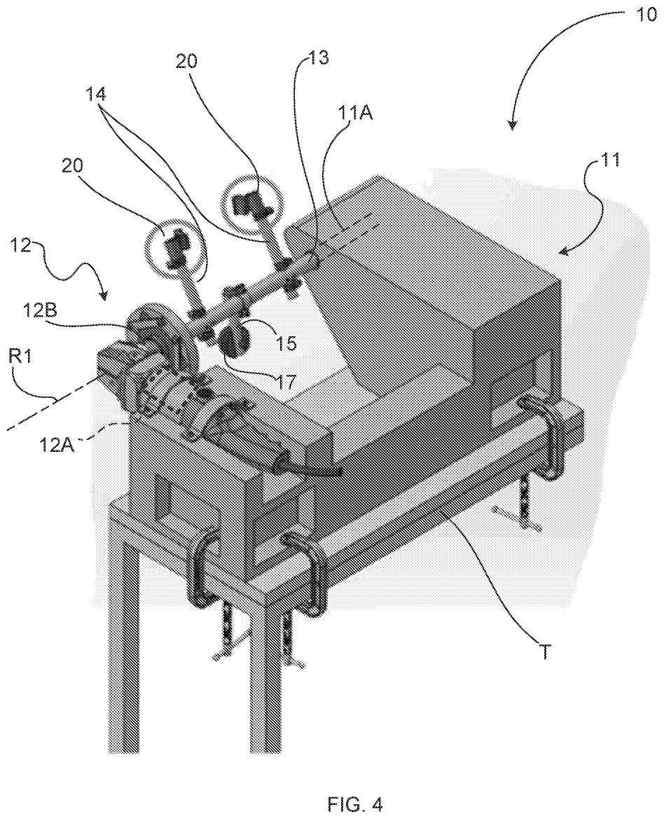

Referring more particularly to FIG. 4, the oscillating device 10 includes a frame or casing 11 onto which is mounted an oscillating actuator 12. The casing 11 may be clamped to the table T using any suitable means such as clamps, fasteners, and so on. In some other embodiments, the oscillating device 10 may be integrated to the table T. In the embodiment shown, the oscillating actuator 12 includes an electric motor 12A in driving engagement with an oscillating shaft 12B. The electric motor 12A may be replaced by any suitable actuators. Upon powering the oscillating actuator 12, the electric motor 12A induces a rotational reciprocating motion of the oscillating shaft 12B about a rotation axis R1 of said oscillating shaft 12B. In one embodiment, this reciprocating motion of the oscillating shaft 12B includes clockwise and counter clockwise movements of the oscillating shaft 12B by about 1.5 degrees in both direction from an at-rest position of the oscillating shaft 12B. In other words, upon the powering of the electric motor 12A, the oscillating shaft 12B rotates by about 1.5 degrees from its initial position in a clockwise direction to a first end position and then moves from the first end position in a counter clockwise direction to a second end position opposite the first end position and located on an opposite side of the first end position. Stated differently, an angular amplitude of movements of the oscillating shaft 12B may be from about 1.5 degrees to about 3 degrees.

The oscillating actuator may be an electro-magnetic vibration device or may include piezo-electric elements. Corresponding devices may cause change of the transmission design (but not necessarily in the vibration frequency, amplitude, and the sites of application to the insertion sites of the muscles connected to the hyoid bone). Incorporation of an alternative source of vibrations may result in a modified design with the installation close to the patient's head on the back of the patient's chair instead of the table, since piezo-electric elements may not need any long mechanically driven arms, they will act directly. If the oscillating actuator includes piezo-electric elements or electro-magnetic vibration, the frame may, in certain embodiments, be omitted. For instance, those oscillating actuator and their respective pads can apply vibrations to target sites when held assembled by means of an adjustable harness worn on the patient's shoulders and/or head. In some alternate embodiments, the pads may be temporarily adhered (e.g., glued) to the skin of the patient at the sites where vibrations should be applied.

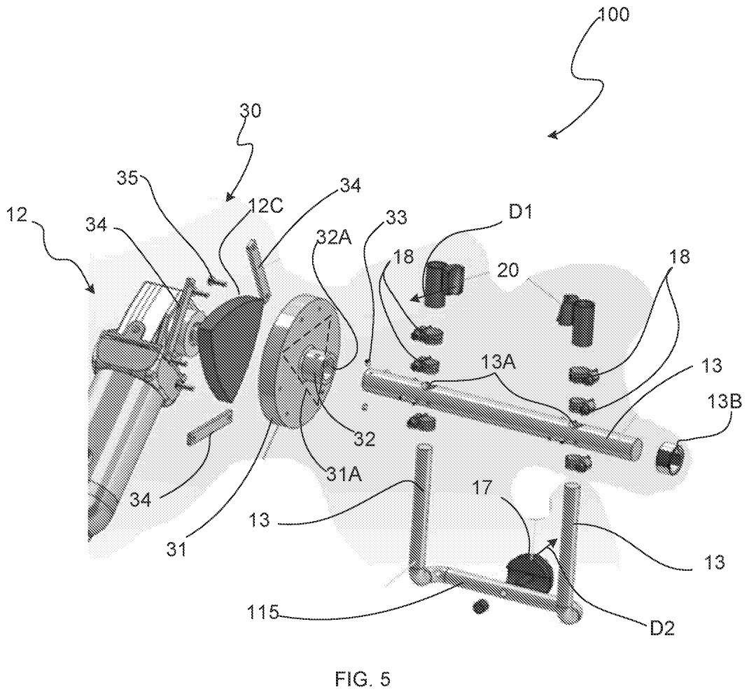

In the depicted embodiment, the oscillating shaft 12B is drivingly engaged to a central shaft 13 of the oscillating device 10. The central shaft 13 may be made of steel or any other suitable sufficiently rigid material. Light materials to minimize inertia, such as aluminum or a polymer material, may be used. The shaft 12B may be tubular, but other shapes are contemplated. The central shaft 13 and the oscillating shaft 12B are engaged to one another and are coaxial with one another in this present embodiment. In an alternate embodiment, a gearbox or any other suitable transmission means may be provided between the oscillating shaft 12B and the central shaft 13. This gearbox or other transmission means may be used to vary an amplitude of movements of the central shaft 13 relatively to that of the oscillating shaft 12B. In the embodiment shown, a distal end of the central shaft 13 relative to a distance from the oscillating actuator 12 is rollingly engaged within an aperture 11A defined through the casing 11. One or more bearings 13B (FIG. 5) may be used to radially support the distal end of the central shaft 13 relative to the casing 11. This bearing 13B may be received within the aperture 11A of the casing 11. In some other embodiments, the central shaft 13 may be cantilevered.

Still referring to FIG. 4, two arms 14 are secured to the central shaft 13. The two arms 14 may be made of steel or any other suitable material such as aluminum or a polymer material. The two arms 14 extend in a direction having a radial component relative to the rotation axis R1. The two arms 14 may be parallel to one another in one embodiment, or can be divergent towards the mandible. When the arms 14 are non-parallel to one another, the larger distance between the ends of the arms 14 is selected to accommodate a larger-size mandible and will exert a higher linear amplitude. Conversely, a smaller mandible will be engaged by the two arms 14 nearer to the rotating shaft 13, and as such a distance the linear amplitude will be suitably lower. The two arms 14 may be referred to as mandible-engaging arm interchangeably in the present disclosure. The two arms 14 may be moved axially relative to the rotation axis R1 along the central shaft 13 to cater to different sizes of patients' heads. A length of the two arms 14 may be adjusted if need be to cater to different sizes of patients' heads.

The oscillating device 10 further includes a lower arm 15, referred to as a sternum-engaging arm, secured to the central shaft 13. The lower arm 15 extends in a direction having a radial component relative to the rotation axis R1. The lower arm 15 extends away from the two arms 14. The lower arm 15 may be substantially axially centered between the two arms relative to the rotation axis R1. In some embodiments, the lower arm 15 may be moved axially along the central shaft 13. A length of the lower arm may be adjusted if need be to cater to different sizes of patients' heads. The lower arm can be angularly inclined towards the patient, so that in the side view the angle between the two arms 14 and the lower arm 15 is open towards the patient and is less than 180°. The exact angle may be adjusted depending on the patient natural posture and body size of the patient.

In use, the angular recursive rotation of the shaft 12B is transmitted to the two arms 14. The linear displacement at the top of the two arms 14 is directed by the arm's length and is of the order of magnitude about 1-4 mm. For example, in one embodiment, the two arms 14 displace linearly with an amplitude of about 2.3 mm. The lower arm 15 displace linearly with an amplitude of about 1.9 mm. These displacement values may be regulated by elongating or shortening the two arms 14 and the lower arm 15. That is, the longer the arm, the larger the linear amplitude.

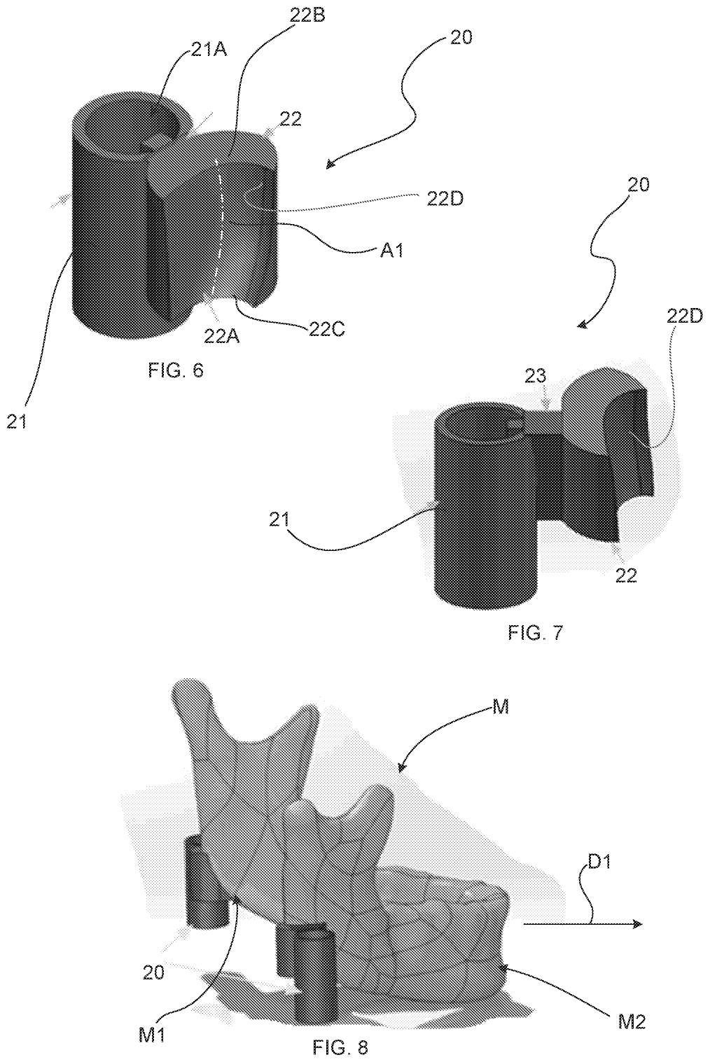

To assist in focussing the vibrations induced by the oscillating actuator 12 to the proper location on the patient, the oscillating device 10 is equipped with mandible-engaging onlays, simply onlays 20 herein below, and a sternum-engaging pad 17. The sternum-engaging pad 17 and the onlays 20 may be made of a thermoplastic elastomer. They may be manufactured by additive manufacturing. Alternatively, the onlays can be manufactured from polyvinyl siloxane putty on the spot (a common dental impression material) to ensure maximal congruency with the vibration application sites. The onlays 20 are mounted at distal ends of the two arms 14 whereas the sternum-engaging pad 17 is mounted at a distal end of the lower arm 15. These onlays 20 are described further below with reference to FIGS. 6-8. In some embodiments, the amplitude of the oscillating motions imparted by the oscillating actuator 12 is such that the onlays 20 and sternum-engaging pad 17 have an amplitude of movements of about 2 mm. Herein, the expression “about” implies variations of plus or minus 10%. The onlays 20 and the sternum-engaging pad 17 are located on opposed locations relative to the rotation axis R1 such that rotation of the central shaft 13 moves the onlays in a direction opposite that of the sternum-engaging pad 17. In the current embodiment, the tapping on the paired mandibular sites and the single sternal site is synchronous.

It will be appreciated that, in some embodiments, more than one oscillating actuator may be used. For instance, if a non-mechanical source of oscillations is used, such as piezo-electric or electro-magnetic sources, each tapping site may include its own respective oscillating actuator. Each of the oscillating actuators may be engaged to a respective one of the onlays 20 and the sternum pad 17. This may allow to select synchronous or asynchronous movements of the onlays 20 and sternum pad 17.

Referring now to FIG. 5, an alternative embodiment of the device is shown at 100 in an exploded view. As shown, the central shaft 13 includes two bores 13A each sized to accept a respective one of the two arms 14. In the present embodiment, the two arms 14 are connected together via a transverse arm 115. The sternum-engaging pad 17 is secured to the transverse arm 115. In this embodiment, the lower arm 115 is continuous from the two arms 14.

In the present embodiment, the two arms 14 are held in place in relationship to the central shaft 13 using worm gear clamps 18. These worm gear clamps 18 may be tightened around the two arms 14 and located on opposite sides of the central shaft 13 to limit translation of the two arms 14 relative to the central shaft 13 within the bores 13A. It will be appreciated that any suitable means may be sued to hold the two arms 14 in place relative to the central shaft 13. For instance, a fastener may be threadingly engaged to the central shaft 13 and have an end protruding in to the bore 13A to engage the two arms 14. Other configurations, such as the bayonet mount or alternative fastening mechanisms, are contemplated.

In the embodiment shown, a coupling 30 is used to drivingly engage the oscillating actuator 12 to the central shaft 13. The coupling 30 includes an interfacing member 31 that acts as an interface between an effective end 12C of the oscillating actuator 12 and the central shaft 13. The interfacing member 31 has a cylindrical portion 32 defining a passage 32A sized to accept the central shaft 13. Screws 33 may be used to secure the central shaft 13 to the cylindrical portion 32 within the passage 32A. The interfacing member 31 includes a recess 31A having a shape that substantially match that of the effective end 12C of the oscillating actuator 12. The shape may be triangular with arced sides. Locking plates 34, three in the embodiment shown, but more or less is contemplated, may be used to lock the effective end 12C of the oscillating actuator 12 into the recess 12D defined by the interfacing member 31. Screws 35 may be used to secure the locking plates 34 to the interfacing member 31. It will be appreciated that any other suitable coupling may be used without departing from the scope of the present disclosure. The interfacing member 31 and the locking plates 34 may be made of aluminum in one embodiment. This coupling may be omitted altogether should an alternative (non-mechanical) source of vibrations be used.

Referring now to FIGS. 6-8, the onlays 20 are described in detail. The onlays 20 includes a cylindrical section 21 being hollow and defining a central passage 21A sized to accept the two arms 14. In other words, the onlays 20 are used to cover distal ends of the two arms 14. The on-lay 20 includes a mandible-engaging pad 22 that is secured to the cylindrical section 21 via a spacer 23. The mandible-engaging pad 22 defines a mandible cavity 22A that is sized to substantially conform to a shape of a mandible angle M1 (FIG. 8) of the mandible M (FIG. 8). Hence, the mandible cavity 22A may extend along a cavity axis A1; the cavity axis A1 curving from a top end 22B of the mandible-engaging pad 22 to a bottom end 22C of the mandible-engaging pad 22. This curved shape may allow to closely follow the shape of the mandible angle M1. The mandible-engaging pad 22 may be made of a thermoplastic elastomer. They may be manufactured by additive manufacturing or by direct manual chair-side modeling using polyvinyl siloxane putty.

As shown in FIG. 7, the mandible-engaging pad 22 defines a mandible-abutting face 22D that partially circumscribe the mandible cavity 22A and that faces a direction oriented forwards, toward a chin M2 and towards the angle and the body of the mandible M. This mandible-abutting face 22D may therefore be able to push on the mandible M in a forward direction D1 when the oscillating device 10, 100 is in use. This application point may correspond to the muscle insertion sites for the following muscles, bilaterally: masseter, medial pterygoid, and mylohyoid. As shown in FIG. 5, and in the present embodiment, the movement of the onlays 20 along the forward direction D1 occurs simultaneously as a movement of the sternum-engaging pad 17 along a rearward direction D2 opposite the forward direction D1. Hence, the mandible angle M1 may be impacted by the mandible-engaging pad 22 at the same time as the sternum (FIG. 1) may be impacted by the sternum-engaging pad 17. In other words, all three strokes may occur in-phase. In some other embodiments that involve independent sources of vibrations instead of a single source and transmission, a slight delay may be possible between the impacts on the mandible M and the impact on the sternum. In other words, the impacts on the mandible and sternum may be out of phase. In the present case, however, the mandible is synchronously impacted with the sternum while expecting that a synergistic effect could be obtained for higher efficacy of the muscle tone reconditioning. However, as long as the vibration frequency and amplitude are within the empirically optimized range, out-of-phase tapping may prove effective.

The onlays 20 may be fully customizable for each patient's mandible. The cylindrical section 21 may be sufficiently stiff to ensure proper transmission of the vibrations to the mandible from the two arms 14. The cylindrical section 21 may be customizable. For instance, an angle between the cylindrical section 21 and the mandible-engaging pad 22 may be varied as a function of patient's anatomy. The spacer 23 may also be customizable for proper vibrations transmission. For instance, a length of the spacer 23 may be selected to vary a distance between the cylindrical section 21 and the mandible-engaging pad 22. The purpose of varying the length of the spacer 23 is to ensure that a smaller size face and/or a narrower transverse dimension of the mandible are accommodated snugly between the mandibular onlays 20. In some embodiments, chair-side fabrication of siloxane putty may ensure the best congruency between the face and the onlays 20, whereas indirect fabrication by additive manufacturing may be more durable. A hybrid method can be foreseen where generic prefabricated onlays will be customized by adding an accommodating layer of siloxane putty between the on-lay and the patient face. This hybrid method would be precise and hygienic.

The principle behind the oscillating devices and related systems as disclosed herein is the correction of posture via reconditioning and relaxation of several muscles that control the position of the mandible. Of all the muscles that control the posture of the mandible, some have their bone attachment sites located superficially. At the mandibular angle and the lower border of the mandible, the muscles of interest are the masseter and medial pterygoid (classic mandible closers), and mylohyoid (the floor of the mouth muscle that participates in mandible opening and mandible retrusion via the hyoid retractors stylohyoid and digastric posterior). At the upper border of the sternum, there are the attachment sites of the sternohyoid, sternothyroid/thyrohyoid, and omohyoid muscles (all of them belonging to the hyoid depressors functional group). Since forceful retraction and retrognathic positioning of the mandible is impossible without the simultaneous engagement of the fourteen aforementioned muscles (seven on both sides), it is assumed that the relaxation of this muscles may result in alleviation of the mandible retraction and retrognathic occlusion. This may involve slight advancement of the mandible M while abolishing the persistent spastic state of all the muscles involved in mandibular movement. It may thus restore their appropriate iterative contractile ability while also unloading the TMJ and dentition.

The tapping parts may thus exert high frequency vibrations on the attachment sites of the muscles that are involved in parafunctional activity. The effective amplitude of oscillation may from 1 mm to 5 mm, preferably from 1 mm to 3 mm. The oscillating actuator 12 of the oscillating device 10 may rotate the central shaft 13 at a frequency of about from 100 to 300 Hz in a recursive tapping mode based on the average dimensions of the human mandible and neck, the average length of the neuromuscular circuits in the craniofacial area, and the neural impulse propagation speed. In other words, the frequency is selected such that the time elapsed between two successive strokes of the onlays on the mandible M and the sternum is shorter than the collective time it takes for the following events to occur: i) a vibration stroke to trigger the Golgi spindles of the tendon at the muscle insertion site, ii) a proprioceptive signal from the Golgi spindle to travel to the motor ganglia of the brain stem, iii) an invoked corrective efferent impulse to travel back to the muscle via the motoneuron, iv) a triggered neuromuscular synapse discharge to induce muscle contraction, and v) the myocytes to regain their contractility after a short post-firing refractory period. Considering the distances between the aforementioned anatomical entities and the speed of impulse travel, the suggested effective frequency range is between 60 and 600 Hz, most likely between 100 and 300 Hz. It is likely that separate optimal frequencies are required to act on the hyoid depressors via the sternal on-lay and on the mandible closers and openers via the mandibular onlays. The presence of two separate optimal frequencies, or the lack thereof is unknown, and it will be established during clinical tests. The vibrating elements of the oscillating device 10, 100 may rest on the mandibular angle and the upper part of the sternum (chest bone) to reach at least some of the attachment sites of the implicated muscles. The attachment sites of the hyoid retractors located directly on the hyoid bone cannot be accessed without inflicting acute discomfort and a feeling of choking on a patient. The target sites for vibration are the tendon attachments of the mandible openers, hyoid depressors, and the floor of the oral cavity, targeting the muscles innervated by the trigeminal nerve, hypoglossal nerve and the anastomotic branches of the intervertebral C2/C3 nerves. The directly inaccessible hyoid retractor muscles are innervated by the facial nerve, and could be accessed indirectly by reducing the tone of the mimic musculature (that also receives motor innervation from the facial nerve branches). The oscillating device 10, 100 may thus achieve relaxation of all the involved functional muscle groups, reposition the mandible into a neutral position, and thus at least partially alleviate TMJ dysfunctions/parafunctions, pain and obstructive sleep apnea.

Historically, “full body vibration” via a vibrating platform is a physiotherapy method used to improve athletic performance and increase muscle and bone mass. However, targeting the muscles responsible for TMJ disorder may be impossible with those full body vibrations devices because of the inherent shock-absorbing system of the joints in the legs and feet, and the shock-absorbing role of the spine—by the evolutionary design, the impacts delivered to the feet are successfully dissipated throughout the body. Delivering vibrations to the mandible through a teeth-borne appliance would face the same problem of impact dissipation because of the shock absorbing nature of the periodontal ligament that suspends the tooth inside its socket in the jaw. The disclosed oscillating device 10, 100 targets the muscles that are connected to the hyoid bone indirectly by impacting the related muscle attachment sites on the sternum and the mandible. As a result, it bypasses the shock-attenuating adaptations that exist at the whole body anatomical level and at the level of the dental arches. Thus, the oscillating device 10, 100 may exert anti-spastic vibrations onto the muscles of the neck and mandible targeting them with a minimal shock attenuating effect. It was found, by the inventors of the present disclosure, that the optimal frequency for the neck application may need to be significantly higher than the frequency used for the legs and core musculature in the full-body treatment, perhaps up to 300 Hz or even higher. The oscillating device 10, 100 may be able to operate in a frequency range that may allow the settings for the muscle tone inhibition that may deploy both negative feedback loops—the tendon spindle loop and the collective refractory period of the myocytes. In some embodiments, each treatment session may last about 10 minutes. These sessions may occur, for instance, three times per week. The schedule of the reconditioning oscillating treatment for the mandibular posture may be refined during clinical tests.

The oscillating device 10, 100 may be used for a method of treatment of the TMJ disorders by applying vibrations of the frequency range between 100-300 Hz to the mandibular angles on both sides and the sternum. The application of vibrations to the accessible attachment sites of the muscles indirectly involved in TMJ movement (via a closed kinematic chain) is transmitted by the pads/onlays, whose geometry will be refined to ensure more targeted or more diffuse tapping, in the course of clinical tests. The vibration range may be above a perceptible tactile mechanical taping/oscillation range and may be perceived by the subject as a low-pitch humming sound. The oscillating device 100 has a layout in which the tapping is delivered in a seesaw manner in two opposing directions: from the front towards the subject's sternum, and from the back towards the subject's mandibular angle (bilaterally). In this way, the strokes may be delivered to all three application points in phase or synchronously, which may result in a synergistic effect.

The range of vibrations may be extended in some cases. The oscillating device may be re-sized if need be. The rigid arms bearing the anatomical onlays 20 may be further customized and may be 3D-adjustable. The oscillating actuator 12 may be a source of acoustic, electromagnetic or piezoelectric vibrations. The device may be designed to be used in patient's home instead of at a clinic.

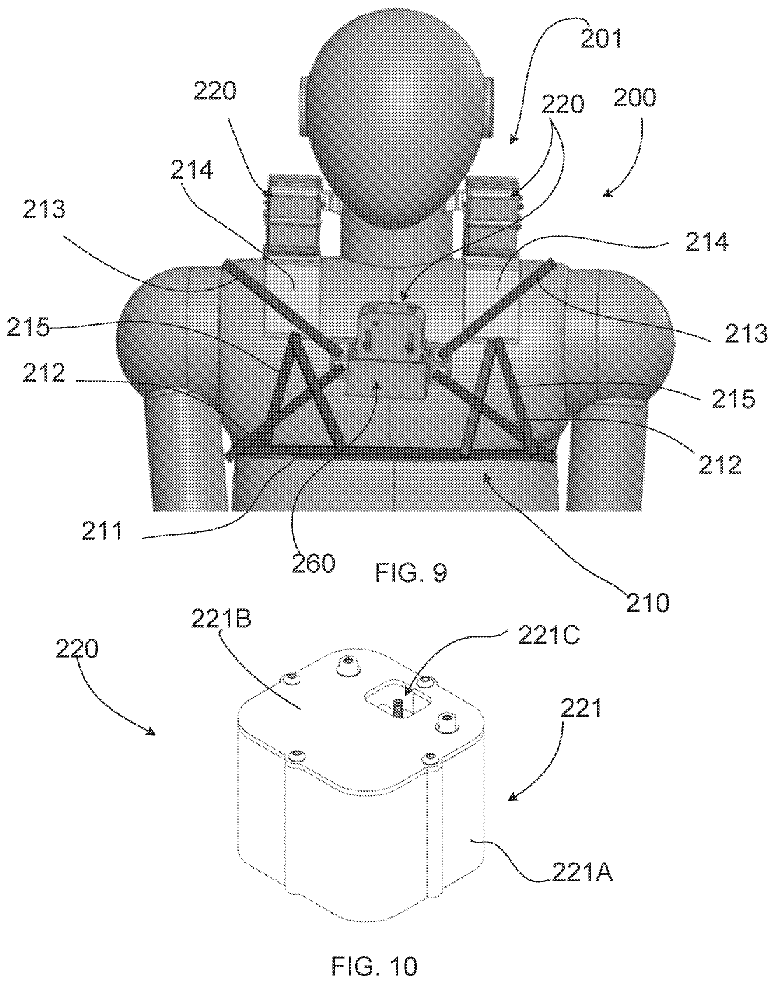

Referring now to FIGS. 9-10, a system for temporomandibular joint disorder is shown at 200. The system 200 includes an array of vibration units 201 spaced apart from each other. Each of the vibration units 201 includes an actuator 220 engaged to a pad, namely three pads each engaged to a respective one of two sides of a mandible of the user and a chest of the user. The system 200 uses a harness 210 to secure the three actuators to the user. The harness 210 is further described below. The system 200 includes at least one support for supporting the vibration units 201. In this embodiment, the system 200 includes three supports: two shoulder-mounted supports 214 for supporting the two vibration units 201 that are engaged to the two pads that abut the mandible of the wearer, and a chest-mounted support 260 for supporting the vibration unit 201 that is engaged to the pad abutting the chest of the user.

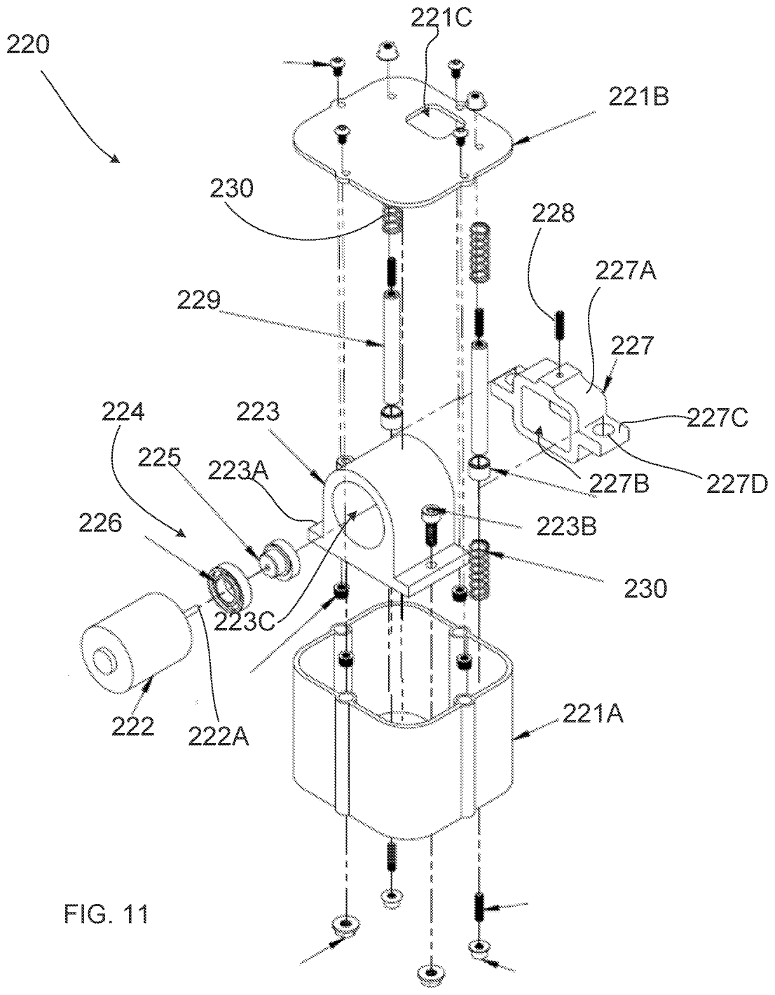

Referring to FIGS. 10-11, the actuators 220 are described in greater detail using the singular form for simplicity. The below description may apply to each of the actuators 220 employed in the system 200.

The actuator 220 includes a casing 221 sized for receiving inner components described herein below. The casing 221 includes a main body 221A and a cover 221B removably securable to the main body 221A. The cover 221B defines an aperture 221C via which a sternum-engaging pad or a mandible-engaging pad, which are described below, may be secured to the actuator 220. The cover may be omitted in some embodiments.

Referring more particularly to FIG. 11, the actuator 220 includes an electric motor 222, or any suitable actuator, such as an acoustic vibrator, mounted within the main body 221A of the casing 221 via a motor mount 223. Other ways of securing the motor within the main body 221A are contemplated, such as, fasteners, glue, etc. The electric motor 222 may be a brushed DC motor of from 6 to 12V. It may be powered by a power supply of 12V AC to DC and of 11.5 Amps, it may be a power supply of 15V. The electric motor 222 may be operable to generate a torque of about 10.1 N·mm at 180 Hz. The motor mount 223 defines two wings 223A via which the motor mount 223 is secured to the main body 221A of the casing 221 via fasteners 223B or other suitable means (e.g., glue, welding, etc). The motor mount 223 defines a cavity 223C sized for receiving the electric motor 222. The electric motor 222 may be press fit within the cavity 223C of the motor mount 223. Alternatively, the electric motor 222 may be fastened to the motor mount 223. In some other embodiments, the electric motor may be operated with higher or lower voltages than described above. The power source may be batteries. The motor may generate higher or lower torque in some embodiments.

The actuator 220 includes a cam assembly 224 drivingly engaged by the electric motor 222. In the embodiment shown, the cam assembly 224 is secured for rotation to a shaft 222A of the electric motor 222. The cam assembly 224 includes a cam 225 and a bearing 226 mounted to the cam 225 for rotation with the cam 225. The bearing 226 may be used to minimize friction between the cam assembly 224 and a cam follower.

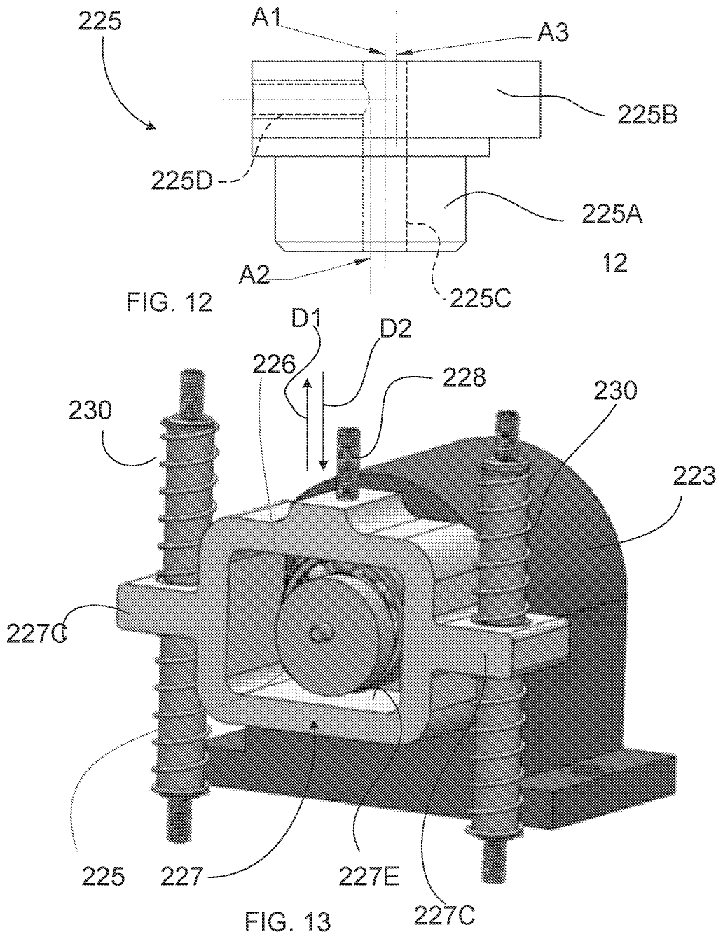

Referring to FIG. 12, the cam 225 includes a first cam section 225A being cylindrical and a second cam section 225B being cylindrical and protruding from the first cam section 225A. The bearing 226 may be mounted on the first cam section 225A. A bore 225C extends through the first and second cam sections 225A, 225B. A central axis A1 of the bore 225C is radially offset from a central axis A2 of the first cam section 225A and radially offset from a central axis A3 of the second cam section 225B. That is, the first and second cam sections 225A, 225B are both eccentric relative to the central axis A1 of the bore 225C and relative to the axis of rotation of the cam 225. The central axes A2, A3 of the first and second cam sections 225A, 225B are radially offset from one another and are located on opposite sides of the central axis A1 of the bore 225C. Therefore, upon rotation of the cam 225 about the central axis A1 of the bore 225C with the shaft 222A of the electric motor 222, a rotational imbalance created by the rotation of the first cam section 225A and of the bearing 226 secured thereto may be at least partially compensated by the rotational imbalance created by the second cam section 225B. The cam 225 may define a threaded bore 225D extending radially relative to the axis A1. The threaded bore 225D opens to the bore 225C and is threaded to receive a correspondingly threaded fasteners used to lock the cam 225 to the shaft 222A of the electric motor 222.

Alternatively, the cam assembly 224 may be simply a single cam drivingly engaged to the shaft 222A of the electric motor 222. That is, the single cam may be cylindrical and may define a bore offset from its center.

Referring back to FIG. 11, in the embodiment shown, the actuator 220 includes a cam follower, referred to below simply as a follower 227. The follower 227 is engaged by the cam assembly 224, more specifically by the bearing 226 of the cam assembly 224. That is, the follower 227 has a body 227A defining a central cavity 227B and two tabs 227C protruding from the body 227A in opposite directions. Each of the two tabs 227C defines an aperture 227D therethrough. A threaded shaft 228 is mounted to the main body 227A of the follower 227. The threaded shaft 228 may extend from the follower 227 in a direction being substantially transverse to the tabs 227C. This threaded shaft 228 is in register with the aperture 221C defined through the cover 221B of the casing 221. The pads may be threadingly engaged to the threaded shaft 228 as described further below.

The actuator 220 includes two shanks 229 mounted to the main body 221A of the casing 221. The two shanks 229 are parallel to one another and extend in a direction being substantially parallel to the threaded shaft 228. The follower 227 is slidingly engaged to the two shanks 229. In the present embodiment, each of the two shanks 227 is slidingly received within an aperture 227D defined through the tabs 227C of the follower 227.

The follower 227 is maintained at a neutral position by biasing members 230, herein springs, engaged to the casing 221 and to the follower 227. In the present embodiment, the biasing members 230 include four biasing members 230 disposed coaxially around the two shanks 229. For each of the two shanks 229, a respective one of the two tabs 227C of the follower 227 is sandwiched between two of the four biasing members 230. Therefore, the follower 227 perceives an upward biasing force by the two biasing members 230 disposed below the tabs 227C and a downward biasing force by the two biasing members 230 disposed above the tabs 227C.

Referring to FIGS. 11-13, in use, the electric motor 222 induces rotation of the cam assembly 224 about the central axis A1 (FIG. 12) of the bore 225C. This causes the bearing 226 to abut the follower 227, more specifically a peripheral inner face 227E (FIG. 13) of the body 227A of the follower 227, and exerting an upward force on the follower 227 to move the follower along direction D1 to compress the biasing members 230 located above the tabs 227C. Further rotation of the cam assembly 224 causes the bearing 226 to abut the follower 227 and exert a downward force on the follower 227 to move the follower along direction D2 opposite direction D1 to compress the biasing members 230 located below the tabs 227C. This movement is repeated thereby inducing a reciprocating motion of the follower 227, and of the threaded shank 228 and pad secured thereto, along directions D1 and D2 in alternation. In the embodiment shown, an amplitude of movements of the follower 227 is from about 1 mm to 5 mm. The speed of rotation of the electric motor 222 may be selected to obtain a frequency of movements of the follower 227 of from 100 Hz to 300 Hz. The follower may have a mass of about 25 g. The biasing members 230 may each have a constant of about 0.992 N/mm to 2.5 N/mm. The constant of the biasing members 230 may be different in some other embodiments.

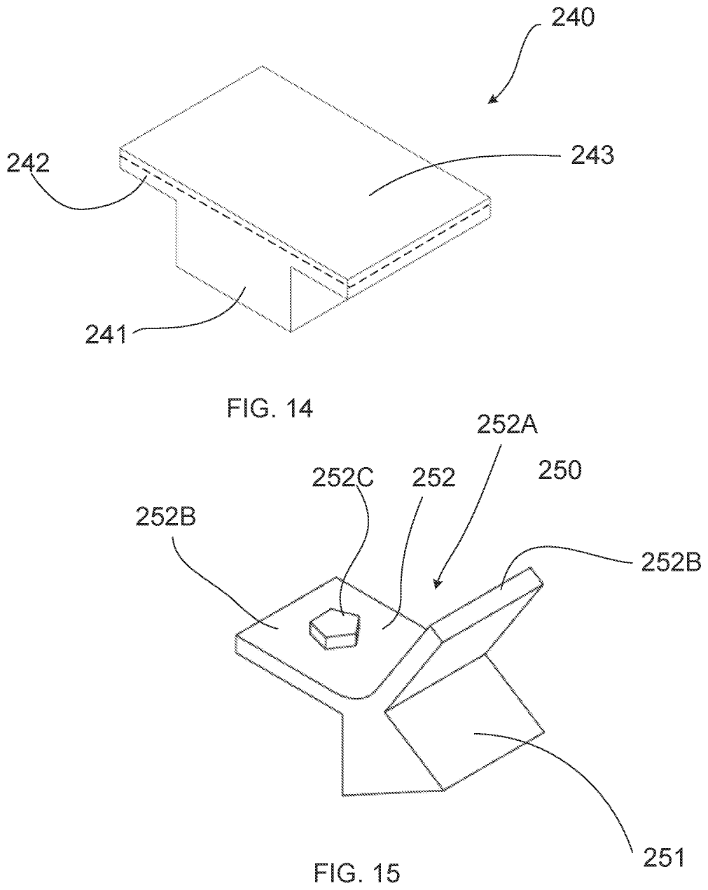

Referring now to FIG. 14, a sternum-engaging pad is shown at 240. The sternum-engaging pad 240, or simply referred to as sternum pad, includes a base 241 threadingly engageable to the threaded shaft 228 of the actuator 220. The sternum pad 240 further includes an engaging plate 242 secured to the base 241. The engaging plate 242 is rectangular shaped in FIG. 14, but other shapes, such as square, circular, hexagonal, and so on are contemplated. An area of the engaging plate 242 may be about 10 cm². The engaging plate 242 may be substantially flat, although may be slight curve to follow a shape of a sternum of the user. The pad 240 may be made any suitable material, such as plastic. An overlay 243, which may be made of polysiloxane or any other suitable customizable or compliant materials, may be disposed over the engaging plate 242 to create an interface with the chest of the user. A longer side of the plate 242 may be aligned to be parallel to a longitudinal axis of the sternum.

Referring now to FIG. 15, a mandible-engaging pad, or mandible pad, is shown at 250. The mandible pad 250 includes a base 251 threadingly engageable to the threaded shaft 228 of the actuator 220. The mandible pad 250 includes a mandible plate 252 secured to the base 251 and that defines a concavity 252A for receiving a mandible angle (e.g., jaw corner) of the user. The concavity 252A may be created by two sections 252B of the plate 252 meeting one another at an angle of about 120 degrees, 123 degrees in some embodiments. This angle may be different and selected to match an angle of the mandible angle.

A protrusion 252C may be located on one of the two sections 252B. The protrusion 252C may be used to anchor an overlay, which may be made of polysiloxane or any other suitable materials, such as customizable or compliant materials, to create an interface with the mandible of the user. The protrusion 252C is shown herein as being hexagonal, but other shapes, such as triangular, square, rectangular, and so on are contemplated. These overlays may be custom made to match shapes of the mandible of the user.

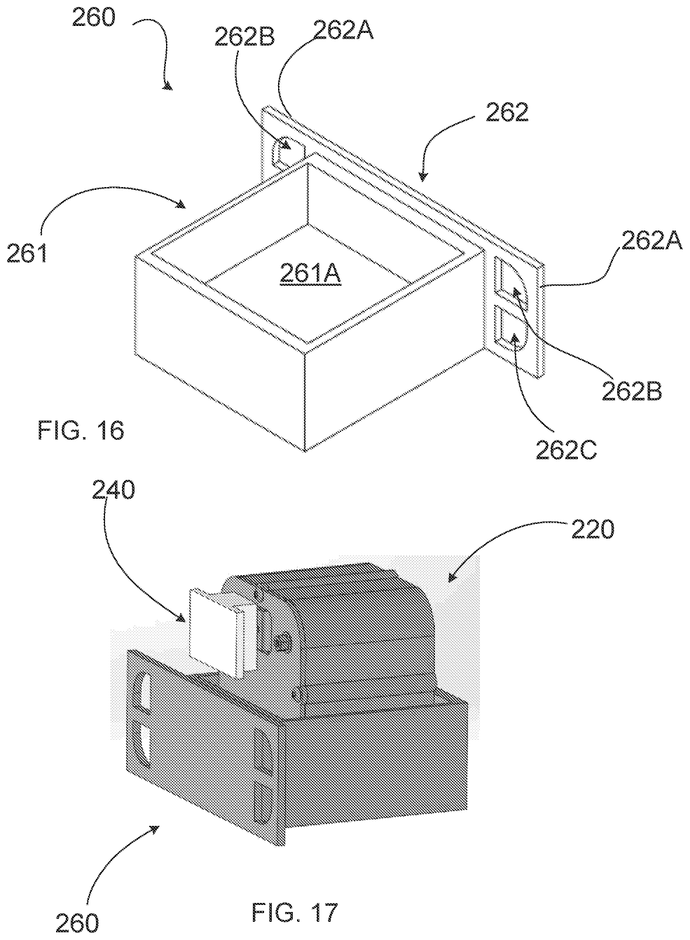

Referring now to FIGS. 16-17, the chest-mounted support 260 includes a container 261 having an inner volume 261A sized for receiving the actuator 220 therein, and a flange 262 secured to the container 261. The flange 262 may be used to attach the chest-mounted support 260, and the actuator 220 it contains, to the chest of the user. More specifically, the flange 262 has opposed sides 262A each defined an upper aperture 262B an a lower aperture 262C. The apertures 262B, 262C may be sized to receive straps of the harness 210 (FIG. 9). More detail about the harness 210 are presented below. The actuator 220 is shown mounted within the inner volume 261A of the chest-mounted support 260 on FIG. 17.

Referring to FIGS. 9 and 16, the harness 210 includes a plurality of straps, namely, a chest strap 211 extending around a torso of the user. Two bottom diagonal straps 212 each secured to the chest strap 211 at a front of the user and to a respective one of the lower apertures 262C of the flange 262 of the chest-mounted support 260 (FIG. 16). Two upper diagonal straps 213 each secured to the chest strap 211 at a rear of the user and to a respective one of the upper apertures 262B of the flange 262 of the chest-mounted support 260.

Two shoulder pads, or shoulder-mounted supports 214 are each disposed over a respective shoulder of the user. An actuator 220 is secured to each of the shoulder-mounted supports 214. Front and rear pad straps 215 are used to secure front and rear ends of the shoulder-mounted supports 214 to the chest strap 211. Other strap arrangements are contemplated without departing from the scope of the present disclosure.

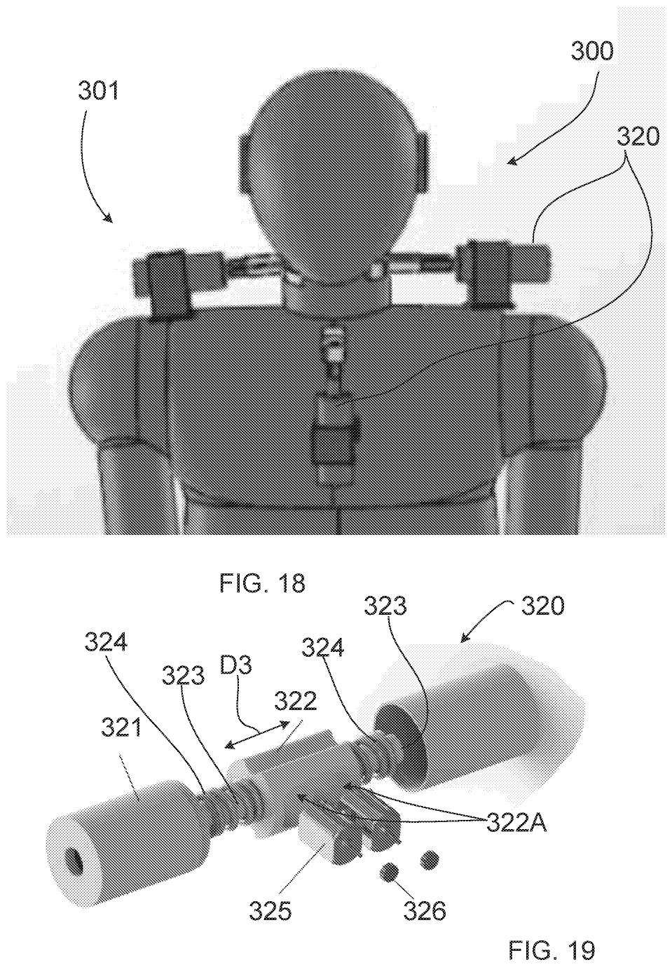

Referring now to FIGS. 18-19, another system for temporomandibular joint disorder is shown at 300. The system 300 may include a similar harness 210 as the one described above with reference to FIG. 8, but removed from FIG. 18. The system 300 includes three vibration units 301 each having an actuator 320 engaged to a respective pad.

The system 300 includes three actuators 320, each may be operatively coupled to a respective one of the pads described above with reference to FIGS. 14-15. Their description will therefore not be repeated here.

Referring more particularly to FIG. 19, the actuator 320 includes a casing 321 being substantially cylindrical and sized to accept inner components including a weight 322 secured to shanks 323. The casing 321 may have two halves securable to one another, such as via a threading engagement therebetween. Two biasing members 324, such as springs, are mounted within the casing 321 around the shanks 323 and exert a force on the weight 322. The weight 322 defines two cavities 322A each receiving a respective one of two electric motors 325 each in driving engagement with an eccentric mass 326. In use, powering of the electric motors 325 induces rotation of the eccentric mass 326 thereby inducing a reciprocating motion of the weight 322 along direction D3. In turn, this movement of the weight 322 induce movements of the pads secured to the actuator 320.

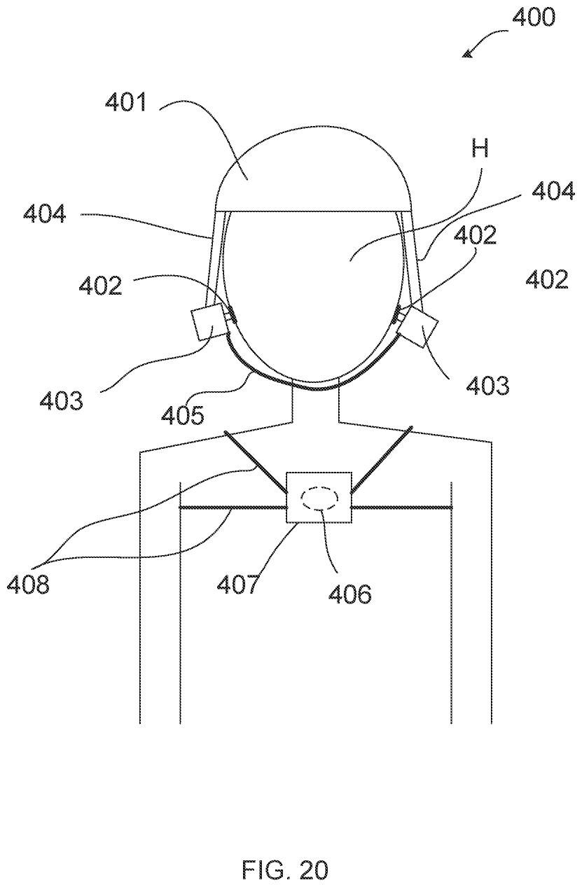

Referring now to FIG. 20, another embodiment of a system for mitigating temporomandibular joints disorders is shown at 400. The system 400 includes a head-mounted support 401 for a head H of a wearer. The head-mounted support 401 may be a helmet or any other suitable device able to be worn on the head H. The system 400, as for the other systems described above, includes an array of vibration units spaced apart from each other. Each of the vibration units including an actuator 403 and a vibrating pad in driving engagement with the actuator 403. The vibration units include a right mandible-engaging unit, a left mandible-engaging unit, and a sternum-engaging unit. The right mandible-engaging unit includes a right mandible-engaging vibrating pad for engaging a right side of a mandible of the wearer. The left mandible-engaging unit including a left mandible-engaging pad for engaging a left side of the mandible of the wearer. The sternum-engaging unit includes a sternum-engaging pad for engaging a sternum of the wearer.

Stated otherwise, the system 400 includes two mandible-engaging pads 402, namely a left mandible-engaging pad for engaging a left side of the mandible of the wearer and a right mandible-engaging pad for engaging a right side of the mandible of the wearer. The two mandible-engaging pads 402 are each drivingly engaged by an actuator 403. The actuators 403 may correspond to any of the actuators 12, 220, 320 described above. The actuators 403 may be acoustic actuators. The actuators 403 are supported to the head-mounted support 401 via straps 404. The straps 404 may be suitably fastened to the head-mounted support 401 and extend downwardly away therefrom. The straps 404 may allow a height adjustment of the actuators 403 to ensure that the mandible-engaging pads 402 are in register with the mandible corners of the mandible of the wearer. The straps 404 may be replaced by rigid brackets or any other means for securing the actuators 403 to the head-mounted support 401. A chin strap 405 may be used to interconnect the two actuators 403 together. The chin strap 405 may be used to bias the two actuators 403, and more particularly the two mandible-engaging pads 402, against the mandible of the wearer. The chin strap 405 may be omitted in some embodiments.

The system 400 further includes a sternum-engaging pad 406 disposed against a sternum of the wearer. The sternum-engaging pad 406 is drivingly engaged by an actuator 407, which may be of the same kind as the actuators 403 that engages the mandible-engaging pads 402. Chest straps 408 are used to secure the actuator 407 to the chest of the wearer. Namely, the chest straps 408 may wrap around a torso of the wearer and above shoulders of the wearer. The chest straps 408 are used to bias the sternum-engaging pad against sternum of the wearer.

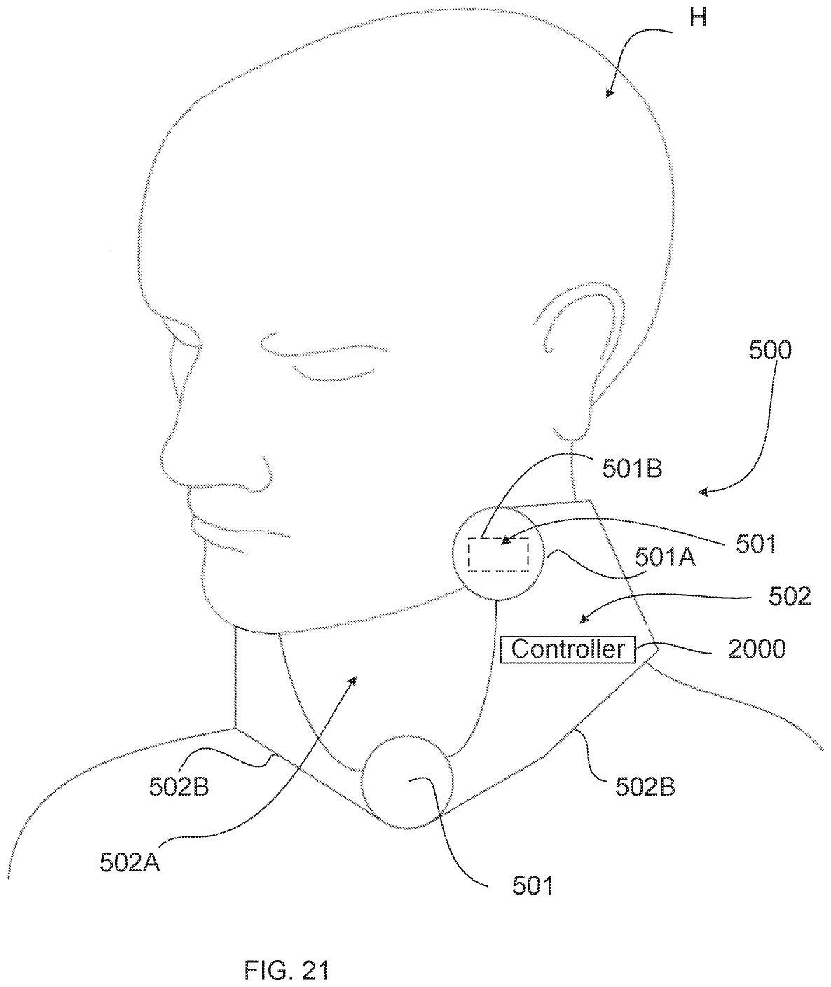

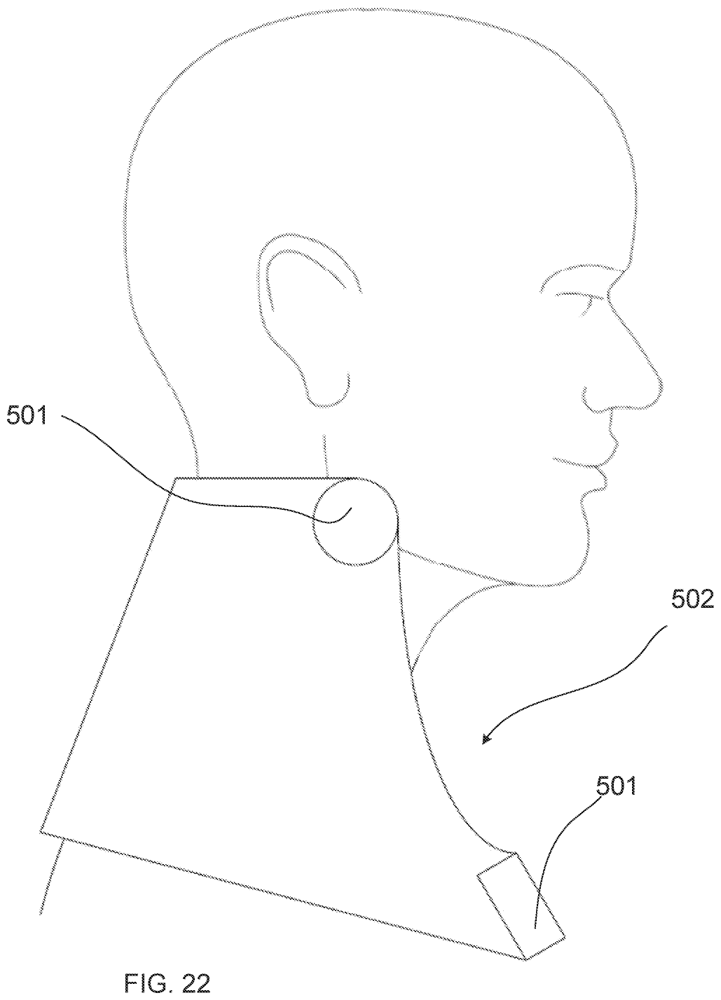

Referring now to FIGS. 21-22, another embodiment of a system for mitigating temporomandibular joints disorders is shown at 500. The system 500 includes three vibration units each including an actuator 501 engaged to a pad. The actuator 501 may correspond to any of the actuators 12, 220, 320 described above. In the present embodiment, the actuators 501 are acoustic actuators comprising a housing 501A enclosing an acoustic vibrator 501B that may be powered for inducing vibrations of one of the pads secured thereto. Two of the vibration units and corresponding actuators 501 are disposed adjacent corners of the mandible of the wearer. A third one of the vibration units and corresponding actuator 501 is disposed adjacent a sternum of the wearer. Although not shown, the actuators 501 are drivingly engaging pads that are in abutment against the mandible and sternum of the wearer. The actuators 501 are supported by a support, which corresponds to a harness 502 in this embodiment. The harness 502 defines a U- or O-shape and has a neck-receiving space 502A sized to accommodate a neck of the wearer. The harness 502 may open at the front to inert the neck of the wearer. Any closing mechanisms, such as clasps, snap buttons, hooks-and-loops fasteners, and so on may be used secure the harness 502 to the wearer. The harness 502 may have bottom padded edges 502B to abut shoulders of the wearer for added comfort during use. As shown more particularly in FIG. 22, the harness 502 may wrap around a back of the neck of the wearer.

The oscillating actuator may be an electro-magnetic vibration device including voice coil or another acoustic vibration generator coupled to a moving membrane, or may include piezo-electric elements. Voice coil actuators may allow for up to 134 mm displacement of the coil, or up to 101 mm displacement of the magnet, and up to 500 Hz frequency. For the frequency of 200 Hz a displacement of 0.5 mm is achievable. The actuator(s) can also consist of several piezoelectric elements assembled into a stacked configuration and coupled to an amplification mechanism capable of increasing the amplitude of oscillations. The operating frequency of each piezoelectric stack can be individually controlled by an external driver. The piezoelectric amplifier architectures may include, for instance, displacement amplifier mechanism for piezoelectric actuators design using SIMP topology optimization approach, and mechanically amplified large displacement piezoelectric actuators.

As for the other systems, a controller 2000 may be used to operatively control operation of the actuators 501. The controller 2000 may be embedded or secured in any suitable manner to the harness 502. Suitable wiring may operatively connect the controller 2000 to the actuators 501. The controller 2000 may be detached from the harness 502 and connected to the vibration units via suitable wiring. The controller 2000 and the actuators 501 may be powered by a power source. The power source may be batteries secured to the harness 502. Alternatively, the harness may be plugged into an outlet. A transformer may be used to modify a voltage supplied to the actuators 501 if need be. The transformer maybe secured to the harness 502, or may be a separate component.

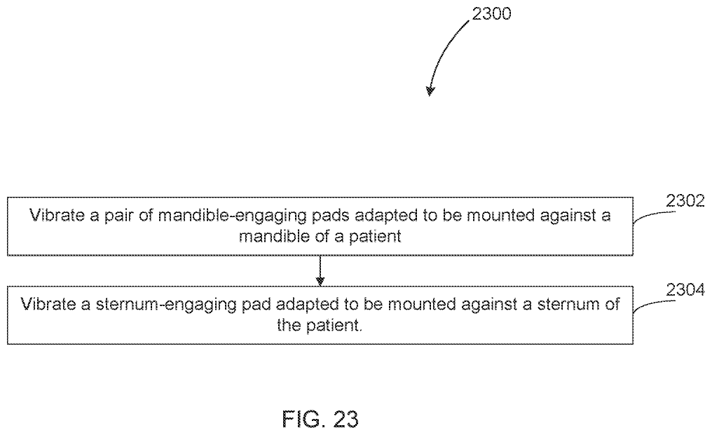

Referring now to FIG. 23, a method of operating a system adapted for mitigating temporomandibular joint disorders is shown at 2300. The method 2300 includes vibrating a pair of mandible-engaging pads adapted to be mounted against a mandible of a patient at 2302; and vibrating a sternum-engaging pad adapted to be mounted against a sternum of the patient at 2304.

The vibrating of the pair of the mandible-engaging pads at 2302 and the vibrating of the sternum-engaging pad at 2304 may include vibrating the pair of the mandible-engaging pads and the sternum-engaging pad with three actuators each drivingly engaged to a respective one of the mandible-engaging pads and the sternum-engaging pad. The vibrating the pair of the mandible-engaging pads and the sternum-engaging pad with three actuators may include vibrating the pair of the mandible-engaging pads and the sternum-engaging pad with three acoustic actuators. The vibrating of the pair of the mandible-engaging pads and the vibrating of the sternum-engaging pad may include vibrating the pair of the mandible-engaging pads and the sternum-engaging pad at a frequency ranging from 100 Hz to 300 Hz. The vibrating of the pair of the mandible-engaging pads and the vibrating of the sternum-engaging pad may include vibrating the pair of the mandible-engaging pads and the sternum-engaging pad at an amplitude ranging from 1 mm to 5 mm. As shown in FIGS. 20-22, the method 2300 may include supporting the mandible-engaging pads and the sternum-engaging pad with the harness. A neck of a wearer may be received within the neck-receiving space of the harness.

The different systems described herein above may be used for mitigating pains associated with Parkinson's disease.

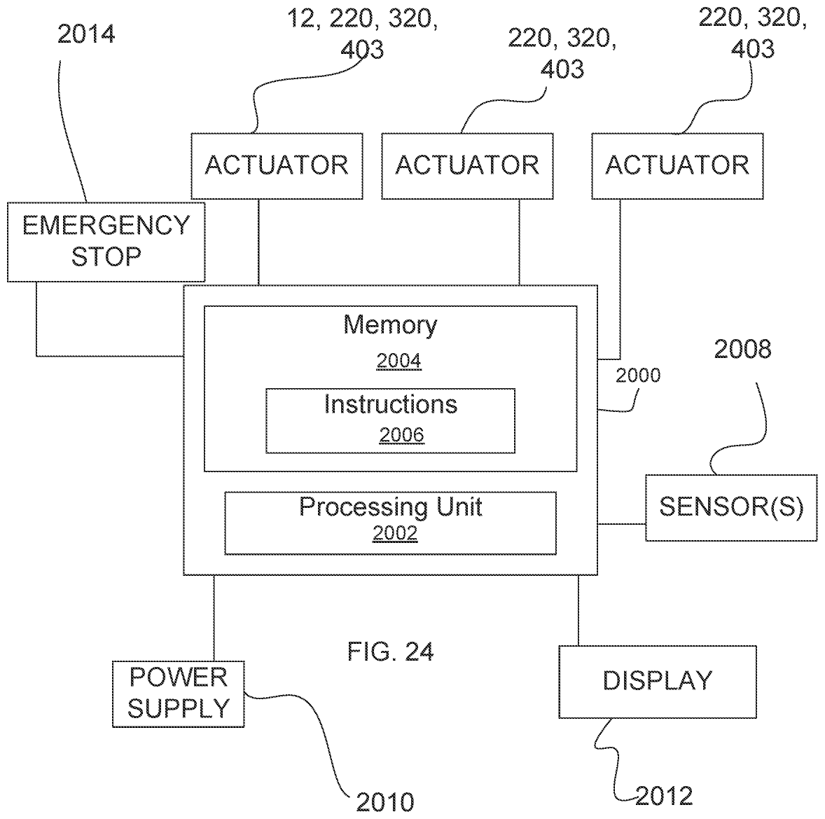

Referring now to FIG. 24, a schematic view of the systems 10, 200, 300, 400, 500 is shown. The actuators 12, 220, 320 may be operatively connected to a controller 2000 to control frequencies of vibrations imparted by said actuators. One or more sensors 2008 may be operatively connected to the controller 2000 and operable to send signal(s) to the controller 2000 about frequencies of the actuators. The controller 2000 may thus control power delivered to these actuators to adjust the frequencies to obtain a desired frequency. The sensor(s) 2008 may further include vital signs sensors or electromyography sensors, for monitoring and data recording purposes.

The controller 2000 may further coordinate the three actuators 220, 320 so that they are substantially synchronous, or asynchronous. For instance, in one embodiment, the controller 2000 may control the actuators 220, 320 such that they impart a pushing force on the user at the same time. In another embodiment, the controller 2000 may control the actuators 220, 320 such that the pushing forces imparted on the mandible and the pushing force imparted on the chest are out of phase.

The controller 2000 may be an Arduino Uno. The actuators and/or controller 2000 may be powered by a power supply 2010 of 12V to 15V, 11.5 Amps. The actuators may include motor driver module, which may include 4-channel H-Bridge motor shields. The controller 2000 may be a PC and may be operable control speeds of the electric motors of said actuators. The controller 2000 may include a display 2012 for displaying motor speeds. An emergency device (e.g., button) 2014 may be used by the user to stop the system.

In some alternative embodiments, the actuators may be any suitable actuating means such as, for instance, piezoelectric actuators with displacement amplifier, voice coils, pneumatic devices, resonance-based actuators, crank and slider actuators, and so on. Magnets may be used to secure the actuators to the user wearing a lead vest; magnets disposed on opposite sides of the vest may hold the actuators in place.

The controller 2000 comprises a processing unit 2002 and a memory 2004 which has stored therein computer-executable instructions 2006. The processing unit 2002 may comprise any suitable devices such that instructions 2006, when executed by the computing device 2000 or other programmable apparatus, may cause the functions/acts/steps performed. The processing unit 2002 may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory 2004 may comprise any suitable known or other machine-readable storage medium. The memory 2004 may comprise non-transitory computer readable storage medium, for example, but not limited to, an electronic, magnetic, optical, electromagnetic, infrared, or semiconductor system, apparatus, or device, or any suitable combination of the foregoing. The memory 2004 may include a suitable combination of any type of computer memory that is located either internally or externally to device, for example random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Memory 2004 may comprise any storage means (e.g., devices) suitable for retrievably storing machine-readable instructions 2006 executable by processing unit 2002.

The methods and systems described herein may be implemented in a high level procedural or object oriented programming or scripting language, or a combination thereof, to communicate with or assist in the operation of a computer system, for example the computing device 2000. Alternatively, the methods and systems may be implemented in assembly or machine language. The language may be a compiled or interpreted language. Program code for implementing the methods and systems may be stored on a storage media or a device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein. Embodiments of the methods and systems may also be considered to be implemented by way of a non-transitory computer-readable storage medium having a computer program stored thereon. The computer program may comprise computer-readable instructions which cause a computer, or more specifically the processing unit 2002 of the computing device 2000, to operate in a specific and predefined manner to perform the functions described herein.

Computer-executable instructions may be in many forms, including program modules, executed by one or more computers or other devices. Generally, program modules include routines, programs, objects, components, data structures, etc., that perform particular tasks or implement particular abstract data types. Typically the functionality of the program modules may be combined or distributed as desired in various embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

The term “connected” or “coupled to” may include both direct coupling (in which two elements that are coupled to each other contact each other) and indirect coupling (in which at least one additional element is located between the two elements).

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

In the context of the present disclosure, the expression “about” implies variations of plus or minus 10%.

The embodiments described in this document provide non-limiting examples of possible implementations of the present technology. Upon review of the present disclosure, a person of ordinary skill in the art will recognize that changes may be made to the embodiments described herein without departing from the scope of the present technology. Yet further modifications could be implemented by a person of ordinary skill in the art in view of the present disclosure, which modifications would be within the scope of the present technology.

1. A system for mitigating temporomandibular joint disorders, comprising:
at least one support adapted to be worn by a wearer;
an array of vibration units mounted to the at least one support and spaced apart from each other, each of the vibration units including an actuator and a vibrating pad in driving engagement with the actuator, the vibration units including a right mandible-engaging unit, a left mandible-engaging unit, and a sternum-engaging unit, the right mandible-engaging unit including a right mandible-engaging vibrating pad for engaging a right side of a mandible of the wearer, the left mandible-engaging unit including a left mandible-engaging vibrating pad for engaging a left side of the mandible of the wearer, and the sternum-engaging unit including a sternum-engaging vibrating pad for engaging a sternum of the wearer; and
a controller in communication with the actuators of each of the vibration units, the controller configured to activate one or more of the actuators in order to induce vibration of the vibrating pad of the respective vibration unit at a selected frequency and amplitude.

2. The system of claim 1, wherein the actuators of each of the vibration units is an acoustic actuator.

3. The system of claim 2, wherein the acoustic actuator includes a housing, an acoustic vibrator engaged to a respective one of the pads, the acoustic vibrator mounted within the housing, actuation of the acoustic vibrator induces a reciprocating motion of a respective one of the pads.

4. The system claim 1, wherein the selected frequency of the vibrations ranges from 100 Hz to 300 Hz.

5. The system of claim 1, wherein the selected amplitude of the vibrations ranges from 1 mm to 5 mm.

6. The system of claim 1, wherein the support is a harness, the left mandible-engaging unit, the right mandible-engaging unit, and the sternum-engaging unit are secured to the harness.

7. The system of claim 6, wherein the harness defines a U-shape having an inner neck-receiving space, the harness shaped to wrap around a neck of the wearer.

8. The system of claim 6, wherein the controller is mounted to the harness.

9. The system of claim 1, wherein the actuator includes:
a housing;
an electric motor mounted within the housing;
a cam drivingly engaged by the electric motor; and
a cam follower engaged by the cam;
wherein actuation of the electric motor induces rotation of the cam about a cam axis and a reciprocating motion of the cam follower about a follower axis.

10. The system of claim 9, comprising two shafts mounted within the housing, the cam follower slidingly engaged to the two shafts.

11. The system of claim 10, comprising biasing members disposed around the two shafts and engaged to the cam follower.

12. The system of claim 9, wherein the pads are mounted on the cam follower of each of three actuators.

13. A method of mitigating temporomandibular joint disorders, comprising:
vibrating a pair of mandible-engaging pads adapted to be mounted against a mandible of a patient; and
vibrating a sternum-engaging pad adapted to be mounted against a sternum of the patient.

14. The method of claim 13, wherein the vibrating of the pair of the mandible-engaging pads and the vibrating of the sternum-engaging pad includes vibrating the pair of the mandible-engaging pads and the sternum-engaging pad with three actuators each drivingly engaged to a respective one of the mandible-engaging pads and the sternum-engaging pad.

15. The method of claim 14, wherein the vibrating the pair of the mandible-engaging pads and the sternum-engaging pad with three actuators includes vibrating the pair of the mandible-engaging pads and the sternum-engaging pad with three acoustic actuators.

16. The method claim 13, wherein the vibrating of the pair of the mandible-engaging pads and the vibrating of the sternum-engaging pad includes vibrating the pair of the mandible-engaging pads and the sternum-engaging pad at a frequency ranging from 100 Hz to 300 Hz.

17. The method of claim 13, wherein the vibrating of the pair of the mandible-engaging pads and the vibrating of the sternum-engaging pad includes vibrating the pair of the mandible-engaging pads and the sternum-engaging pad at an amplitude ranging from 1 mm to 5 mm.

18. The method of claim 13, comprising supporting the mandible-engaging pads and the sternum-engaging pad with a harness.

19. The method of claim 18, comprising receiving a neck of a wearer within a neck-receiving space of the harness.

20. Use of the system of claim 1 for mitigating pains associated with Parkinson's disease.
